(19) United States
(12) Patent Application Publication
(10) Pub. No.: US 2022/0179365 A1
(43) Pub. Date: Jun. 9, 2022

(54) ITEM MADE FROM CERMET AND/OR CERAMIC

(71) Applicant: Comadur SA, Le Locle (CH)

(72) Inventor: Pascal CHOPARD-LALLIER, Montlebon (FR)

(73) Assignee: Comadur SA, Le Locle (CH)

(21) Appl. No.: 17/492,927

(22) Filed: Oct. 4, 2021

(30) Foreign Application Priority Data
Dec. 3, 2020 (EP) 20211403.9

(51) Int. Cl. G04B 19/28; B28B 1/24

(52) U.S. Cl. CPC G04B 19/283; B28B 1/24

(57) ABSTRACT

An item made from cermet and/or ceramic, and in particular a bezel (1) of a timepiece, produced by a method for injecting at least two materials (2, 3) of distinct compositions, the item including a part (4) where the two materials (2, 3) are superimposed and are interleaved one in the other.

### CROSS REFERENCE TO RELATED APPLICATIONS

This application is claiming priority based on European Patent Application No. 20211403.9 filed on Dec. 3, 2020, the disclosure of which is incorporated herein in its entirely by reference.

### TECHNICAL FIELD

The present invention relates to an item obtained by multi-injection of ceramics and/or cermets. It relates more particularly to a horological component such as a bezel produced by injecting ceramics and/or cermets of different colours.

### PRIOR ART

Horological components are commonly produced from injected plastics material with different colours. It is thus possible to obtain middles and bezels having distinct colours. With ceramics or cermets that are obtained by sintering, manufacturing components with different colours is much more complex. This is because significant shrinkage, which may amount to 30%, is observed during sintering. The amount of shrinkage will be dependent on several factors, which are among others the choice of the material and the volume of the material injected. In bi-injection methods or more generally multi-injection methods, differences in shrinking during sintering that will lead to a disconnection at the junction between the various materials may result. More specifically, in the case of injected bezels, a gap related to the difference in radial shrinkage between the materials is observed. This difference is all the more marked if the volumes of material injected are different for the two materials, which is typically the case if one of the materials occupies only a small arc of a circle compared with the other material

To overcome this drawback, it has been proposed in the document EP 2 746 243 to inject a single material and to impregnate a part of the unfired body before sintering with a solution comprising a metal acting as a pigment. This method has the disadvantage that it is difficult to obtain a uniform colour in the mass of the coloured part.

### SUMMARY OF THE INVENTION

The object of the present invention is to overcome the aforementioned disadvantages by proposing a novel method for injecting multi-material limiting the differences in shrinkage between the distinct materials injected.

To this end, the present invention relates to a manufacturing method using, during the injection step, an insert having a structure in relief or hollow intended to impress on the first injected material an attachment surface for the second injected material. This attachment surface makes it possible to hold the second injected material, to reduce shrinkage during the sintering step and to prevent disconnection of the two materials during the machining step.

More precisely, the method for manufacturing the item according to the invention includes the following steps:
Making available at least one first material and one second material, said first material being distinguished from the second material by the chemical composition thereof, said first and second materials being either a ceramic or a cermet,
Making available a mould with a cavity comprising a portion provided with a structure in relief or hollow intended to form the attachment surface on the first material,
Injecting said first material into the cavity provided with the portion so as to impress the structure on a part of the first material and thus to form the attachment surface on said part,
Injecting the second material onto the first material at least at the attachment surface to form an unfired body,
Sintering the unfired body to form a blank,
Finishing the blank to obtain the item.

The method further comprises a machining step before and/or after the sintering step to size respectively the unfired body and/or the blank and to partially remove the second material so as to reveal the first material.

The present invention also relates to the item made from ceramic and/or cermet resulting from the manufacturing method. The item according to the invention includes at least two distinct materials differentiated by the colours thereof, or more generally by the aesthetic appearance thereof, and/or the mechanical properties thereof. According to the invention, the item includes a part where the two materials are interleaved. Preferably, the item includes a part where one of the materials fills hollows formed in the other material.

Other features and advantages of the present invention will emerge in the following description of a preferred embodiment, presented by way of non-limitative example with reference to the accompanying drawings.

### BRIEF DESCRIPTION OF THE FIGURES

FIG. 1 shows a three-dimensional view of the double cavity of the fixed part of the mould with one of the two cavities comprising an insert with a structure in relief according to the invention.

FIG. 2 shows a three-dimensional view of the insert with the structure in relief.

FIG. 3 shows a view in cross section of the mould at the time of injection of the first material on the right and of the second material on the left respectively.

FIG. 4 shows a three-dimensional view of the unfired body resulting from the bi-injection of materials.

FIG. 5A shows a three-dimensional view of the unfired body after machining with a view to producing a dual-colour bezel.

FIG. 5B shows half of the unfired body of FIG. 5A.

FIG. 6 shows a plan view of the bezel resulting from the manufacturing method according to the invention.

### DETAILED DESCRIPTION

The present invention relates to a method for manufacturing by injecting an item or article produced with at least two distinct materials that are either a cermet or a ceramic. Distinct materials means materials differentiated through their aesthetic appearance, in particular their colour, and/or through their mechanical properties. This is represented by differences in chemical composition. It may be a case of the same base material with different pigments for changing the colour or different base materials. By way of example, it may be the same base material based on zirconium oxide with on the one hand a black pigment for obtaining a black material and on the other hand alumina for obtaining the white colour. More generally, ceramics may be nitrides, carbides and/or oxides. Likewise, cermets may include a ceramic phase including carbides, nitrides and/or oxides and a phase of a metal binder selected for example from precious elements such as ruthenium, rhodium, palladium, osmium, iridium, platinum, gold and silver.

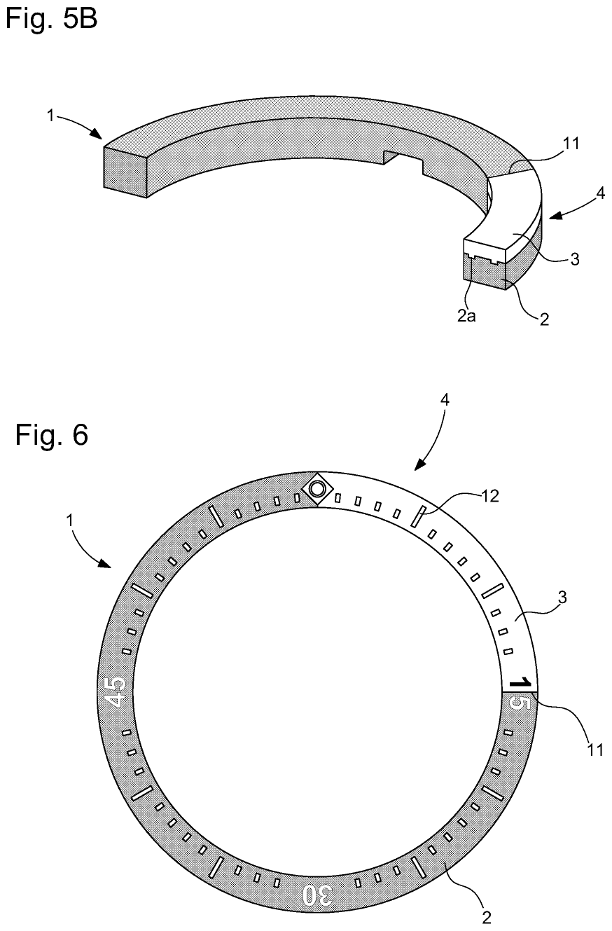

The item according to the invention may be a decorative item or article such as a constituent element of watches, jewelry, bracelets, etc. In the horological field, this item may be an external component such as a middle, a bottom, a bezel, a push-piece, a bracelet link, a dial, a hand, a dial index, etc. It may also be a movement component such as an oscillating mass, a disc, etc. By way of illustration, the item is a bezel 1 produced with two ceramics 2 and 3 of different colours, for example black and white, with one colour that occupies a quarter of the circle of the bezel and another colour that occupies the remaining three quarters of the circle, as shown in FIG. 6. According to the invention, the item includes a part 4 where the two materials 2 and 3 are superimposed and more specifically are interleaved (FIG. 5B). Interleaving means that one of the two materials has on its surface a structure filled with another material. In FIG. 5B, the two materials 2 and 3 can be seen, which are superimposed with the interleaving of one in the hollows 2a formed on the surface of the other.

The item is produced by injecting different materials to form an unfired body or green body and by sintering said unfired body. The manufacturing method is illustrated below for an item comprising two distinct materials but it could be a case of an item comprising 3, 4, etc different materials with the production of an attachment surface for each of the successive injected materials.

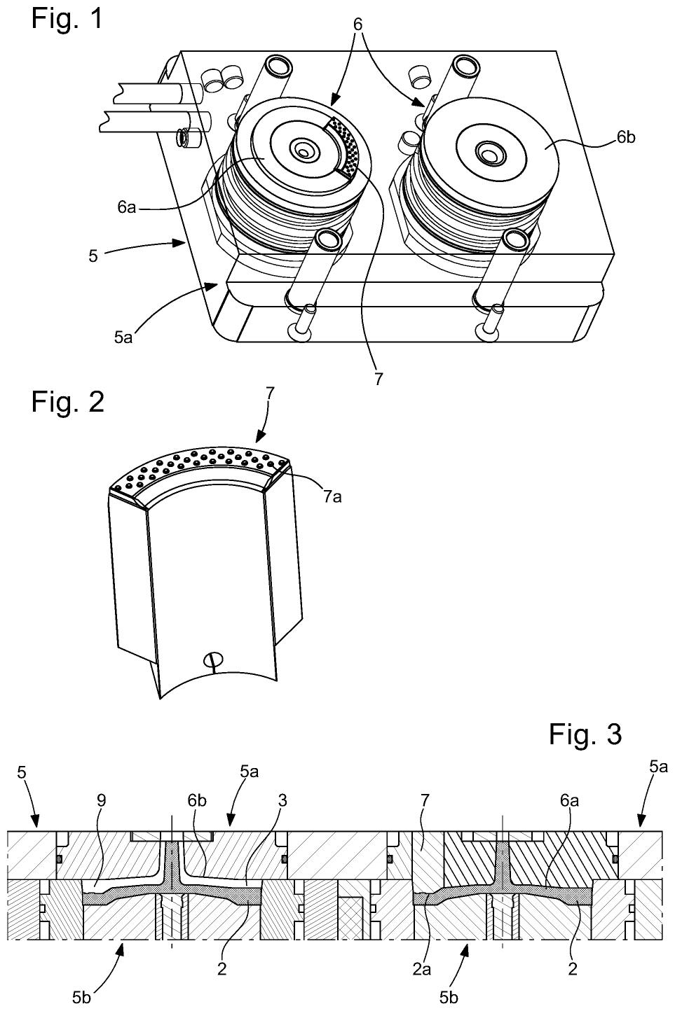

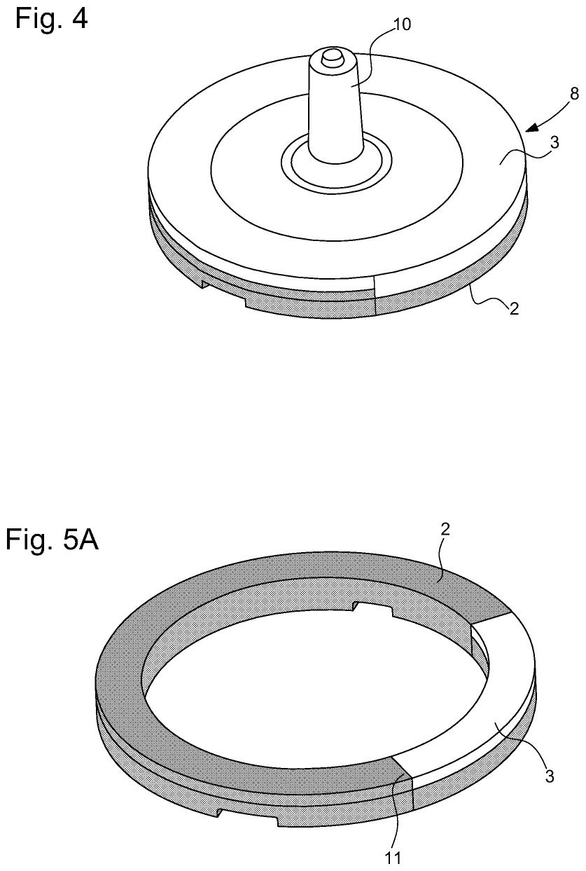

The manufacturing method includes the following steps with reference to FIGS. 1 to 6:
Making available at least one first material 2 and a second material 3, said first material being distinguished from the second material by its chemical composition, said first and second materials being either a ceramic or a cermet. Thus the first and second materials may both be a ceramic or both a cermet or one material may be a ceramic and the other a cermet,
Making available a mould 5 with a cavity 6 comprising a portion 7, also referred to as an insert, including a structure in relief or hollow intended to form an attachment surface on the first injected material (FIG. 1). Preferably, said structure is in relief. This structure is preferably discontinuous. It may thus be formed by a multitude of studs 7a (FIG. 2) or hollows. This discontinuous structure is favoured compared with a continuous structure such as a groove or a tongue for better holding of the material. Preferably, the hollows or studs have respectively a depth or a height at a minimum of 0.2 mm. Preferably, the number of studs or hollows is from 1 to 10, more preferably from 1 to 3, per 10 mm² of surface area,
Injecting said first material 2 into the cavity 6 provided with the insert 7 so as to impress the structure over a part of the first material 2 and thus to form the attachment structure for the second material 3,
Injecting the second material 3 onto the first material 2 at least at the attachment surface to form an unfired body 8 (FIG. 3 and FIG. 4),
Sintering the unfired body 8 to form a blank,
Finishing the blank to form the item.

The method further includes a machining step preferably implemented on the unfired body before sintering so that the material is not too hard. During this machining step, the second material is at least partially removed in order to reveal the first material. The present invention does not exclude the machining step being implemented partly before the sintering and partly after the sintering.

The method may optionally include a step of debinding before the sintering step if the materials have been injected with a system of organic binders (paraffin, polyethylene, etc.).

In the example illustrated, the injection device includes a mould 5 with a fixed part 5a formed by two cavities 6 with a first cavity 6a intended for injecting the first material 2 and a second cavity 6b intended for injecting the second material 3 (FIG. 1). The first cavity 6a includes the insert 7 with the structure in relief. In the example, the insert is attached to the cavity but it could also be in a single piece with the rest of the cavity. At the time of injection, the first material 2 is injected into the mould 5 formed by the fixed part 5a and the movable part 5b as shown in FIG. 3 on the right. Next, the movable part 5a with the first injected material 2 is moved over the fixed part 5b of the other cavity 6b to implement the injection of the second material 3 (FIG. 3 on the left). The insert 7 with a structure in relief is intended to impress hollows 2a in the first material 2 that will serve as attachment during the injection of the second material 3. In the example illustrated, which relates to a bezel having two colours in the same plane, the insert 7 projects with respect to the plane of the cavity 6a so as to form a pocket 9 that will be filled with the second material 3 during the second injection (FIG. 3 on the left). FIG. 4 shows the unfired body 8 resulting from the bi-injection with the second material 3 superimposed on the first material 2. To form a bezel, the sprue 10 is cut and the inside diameter of the bezel is hollowed out. Likewise, the layer of second material 3 is removed with the exception of the layer filling the pocket so as to obtain the blank in FIG. 5A. Removing the second material makes it possible to reveal the first material and to obtain the bezel with the two materials juxtaposed in the same plane. By virtue of the attachment surface formed in the first material, the second material is held during the sintering step, which makes it possible to obtain a perfect junction 11, without any gap, between the two materials. After the sintering, the manufacturing method includes a finishing step that consists in polishing the surface of the sintered blank and where applicable etching the surface, with for example indices 12 in the case of a bezel 1 (FIG. 6). Typically, a bezel 1 according to FIG. 6 is obtained by injecting a white zirconium and a black zirconium and by sintering at a temperature of 1400° C. for a time of 48 hours under an oxidizing atmosphere.

### Legend

(1) Bezel

(2) First material, also referred to as ceramic
a. Hollowing out

(3) Second material, also referred to as ceramic

(4) Part of the item

(5) Mould
a. Fixed part
b. Movable part

(6) Cavity
a. First cavity
b. Second cavity

(7) Insert, also referred to as portion of the cavity
a. Stud

(8) Unfired body

(9) Pocket

(10) Sprue of the unfired body

(11) Junction

(12) Index

1. A method for manufacturing an item made from ceramic and/or cermet by injecting at least two different materials, comprising the following steps:
making available at least one first material (2) and one second material (3), said first material (2) being distinguished from the second material (3) by the chemical composition thereof, said first (2) and second (3) materials being either a ceramic or a cermet,
making available a mould (5) with a cavity (6) comprising a portion (7) having a structure in relief or hollow intended to form the attachment surface on the first material (2) after injection,
injecting said first material (2) into the cavity (6) provided with the portion (7) so as to impress the structure on a part of the first material (2) and thus to form the attachment surface on said part,
injecting the second material (3) onto the first material (2) at least at the attachment surface to form an unfired body (8),
sintering the unfired body (8) to form a blank,
finishing the blank to obtain the item,
said method further including a machining step to size respectively the unfired body (8) and/or the blank and to partially remove the second material (3) so as to reveal the first material (2).

2. The manufacturing method according to claim 1, wherein the structure of the portion (7) is discontinuous.

3. The manufacturing method according to claim 1, wherein the structure of the portion (7) is in relief.

4. The manufacturing method according to claim 3, wherein the structure of the portion (7) is formed by a multitude of studs (7a).

5. The manufacturing method according to claim 1, wherein the structure of the portion (7) is hollow and formed by a multitude of hollows.

6. The manufacturing method according to claim 1, wherein the portion (7) is projecting with respect to the plane of the cavity (6) so as to form a pocket (9) in the first material (2) intended to be filled with the second material (3) during the injection.

7. The manufacturing method according to claim 1, wherein the second material (3) is injected onto the first material (2) to form the unfired body (8) comprising two superimposed layers with a layer of the first material (2) and a layer of the second material (3).

8. The manufacturing method according to claim 6, wherein all the second material (3) with the exception of the material filling the pocket (9) is removed during the machining.

9. An item made from cermet and/or ceramic, comprising at least two materials differentiated through the chemical composition thereof, said two materials being a ceramic or a cermet, wherein it includes a part (4) where the two materials are superimposed and are interleaved one in the other.

10. The item according to claim 9, wherein one of the two materials includes hollows (2a) filled with the other material.

11. The item according to claim 10, wherein the hollows (2a) have a minimum depth of 0.2 mm.

12. The item according to claim 10, wherein the hollows (2a) are present in a number between 1 and 10, preferably between 1 and 3, for a surface area of 10 mm².

13. The item according to claim 9, wherein the item is an external or movement horological component.

14. The item according to claim 13, wherein the external or movement horological component is selected from the list comprising a middle, a bottom, a bezel, a push-piece, a bracelet link, a dial, a hand, a dial index, an oscillating mass and a disc.

15. The item according to claim 9, wherein the two materials are distinguished through their colour.

16. The item according to claim 15, wherein the item is a bezel (1) with at least two distinct colours.

17. The item according to claim 16, wherein a first colour occupies a first arc of a circle and a second colour occupies a second arc of a circle supplementing the first arc of a circle to form the circle of the bezel (1).

18. The item according to claim 17, wherein the first arc of a circle has a size less than the second arc of a circle.

19. The item according to claim 18, wherein the first arc of a circle occupies a quarter of a circle and the second arc of a circle occupies three-quarters of a circle.
